(19) United States
(12) Patent Application Publication
(10) Pub. No.: US 2018/0205505 A1
(43) Pub. Date: Jul. 19, 2018

(54) High Code-Rate Iterative Decoders With Limited HARQ

(71) Applicant: MediaTek Inc., Hsinchu City (TW)

(72) Inventor: Timothy Perrin Fisher-Jeffes, Cambridge, MA (US)

(21) Appl. No.: 15/874,830

(22) Filed: Jan. 18, 2018

Related U.S. Application Data
(60) Provisional application No. 62/447,464, filed on Jan. 18, 2017.

(51) Int. Cl. H04L 1/18; H04L 1/00

(52) U.S. Cl. CPC H04L 1/1816; H04L 1/0071; H04L 1/005

(57) ABSTRACT

Examples pertaining to high code-rate iterative codes combined with HARQ are provided. Proposed architectures of the present disclosure take advantage of the incremental redundancy transmitted to a receiver beyond the limits of what the HARQ can store. In the proposed architectures, internally decoded intrinsic information or extrinsic information are retained that would otherwise be discarded from the final iteration. This is then used in combination with any further new re-transmissions that may be received.

### CROSS REFERENCE TO RELATED PATENT APPLICATION

The present disclosure claims the priority benefit of U.S. Provisional Patent Application No. 62/447,464 filed on 18 Jan. 2017, content of which is incorporated by reference in its entirety.

### TECHNICAL FIELD

The inventive concept described herein is generally related to signal processing in communication systems and, more specifically, to methods, apparatus and systems pertaining to high code-rate iterative decoders combined with hybrid automatic repeat request (HARQ).

### BACKGROUND

Unless otherwise indicated herein, approaches described in this section are not prior art to the claims listed below and are not admitted to be prior art by inclusion in this section.

With various developments in wireless communication technologies, a number of standards for wireless communications are presently implemented in wireless networks throughout the world. Wideband Code Division Multiple Access (WCDMA) mobile wireless systems have enjoyed widespread uptake of high-quality circuit-switched applications like voice and video telephony. Long-Term Evolution (LTE) is a standard for wireless communication of high-speed data for mobile phones and data terminals. It is designed to increase the capacity and speed using a different radio interface together with core network improvements. Time Division Synchronous Code Division Multiple Access (TD-SCDMA) is another standard implemented in Universal Mobile Telecommunications System (UMTS) mobile telecommunications networks in China as an alternative to WCDMA.

In wireless communication systems, bit errors occur during transmission due to noise and multi-path fading. A variety of error control techniques are available for combating transmission errors and reducing bit errors. The hybrid automatic repeat request (HARQ) protocol, which combines automatic repeat request (ARQ) with forward error correction (FEC), represents one exemplary error control technique. ARQ adds redundant bits or check bits to a protocol data unit (PDU) to enable detection of errors at the receiver. If the receiver detects errors in the received PDU, the receiver may send a feedback message, e.g., a NACK, on a control channel that requests a repeat transmission of the PDU. FEC uses error-correcting codes to combat errors by adding redundancy to the PDU before it is transmitted. The added redundancy enables the receiver to detect and correct most errors that occur during transmission.

However, at least with respect to incremental redundancy, HARQ buffer or memory storage is typically limited for the headline rates published by various standards including WCDMA, LTE and TD-SCDMA. These limits impose a lower bound on the codes rates before simple repetition is employed with chase-combining (HARQ-CC) over incremental redundancy (HARQ IR). For example, in W-CDMA, this limit could impose a lower bound of the code rate of as high as 0.97. This may result in headline rates that are difficult, if not impossible, to reach in real-world scenarios.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter. The example architecture used to explain the concepts is that of an iterative turbo decoder architecture but is not in any way limited to this architecture. Other iterative architectures such as iterative LDPC decoders could similarly employ the same concepts to reach the same ends. The same extrinsic information present within any iterative decoder can be exploited in the same manner.

An objective of the present disclosure is to provide schemes, techniques, methods, devices, apparatuses and systems that achieve low-rate codes with limited HARQ storage. In particular, the present disclosure provide implementations that deal with how to modify the receiver to take advantage of the incremental redundancy transmitted to it beyond the limits of what the HARQ can store. In the architectures proposed in the present disclosure, the internally decoded intrinsic information or extrinsic information are retained that would be otherwise discarded from the final iteration. This is then used in combination with any new systematic and parity information bits that may be received through re-transmissions.

In one aspect, a method implementable in a receiver of a communication system may involve the receiver bit separating a stream of bits into a plurality of systematic bits, a plurality of first parity bits, and a plurality of second parity bits. The method may also involve the receiver decoding the systematic bits and the parity bits by performing a number of operations. The operations may include: retaining internally decoded intrinsic information or extrinsic information in lieu of discarding the internally decoded intrinsic information or the extrinsic information; and combining the internally decoded intrinsic information or the extrinsic information with systematic and parity information bits received through re-transmission.

In one aspect, an apparatus may include a receiver having a decoder. The decoder may be configured to decode a stream of bits comprising a plurality of systematic bits and a plurality of parity bits. In decoding the systematic bits and parity bits, the decoder may perform the following: retaining internally decoded intrinsic information or extrinsic information in lieu of discarding the internally decoded intrinsic information or the extrinsic information; and combining the internally decoded intrinsic information or the extrinsic information with systematic and parity information bits received through re-transmission.

Other features and advantages of the present disclosure will become apparent from the following description of various implementations which refer to the accompanying drawings.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a simplified block diagram of an example architecture for high-rate turbo code HARQ in accordance with an implementation of the present disclosure.

FIG. 2 is a simplified block diagram of an example architecture for high-rate turbo code HARQ in accordance with another implementation of the present disclosure.

FIG. 3 is a simplified diagram of an example communication system involving an example receiver in accordance with at least some implementations of the present disclosure.

FIG. 4 is a flowchart of an example process implementable in a receiver in accordance with an implementation of the present disclosure.

FIG. 5 is a flowchart of an example process implementable in a receiver in accordance with another implementation of the present disclosure.

FIG. 6 is a flowchart of an example process implementable in a receiver in accordance with another implementation of the present disclosure.

FIG. 7 is a simplified block diagram of a conventional architecture for high-rate turbo code HARQ.

### DETAILED DESCRIPTION OF PREFERRED IMPLEMENTATIONS

### Overview

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Turbo codes are a class of high-performance forward error correction (FEC) codes closely approaching the channel capacity, which is a theoretical maximum for the code rate at which reliable communication is still possible given a specific noise level. In turbo codes, every information bit influences every other information bit. Thus, if there is an error in the code, every other bits not in error may be utilized to rectify the error in congruity. There are various instances of turbo codes, using different component encoders, decoders, interleavers, deinterleavers, and puncturing patterns.

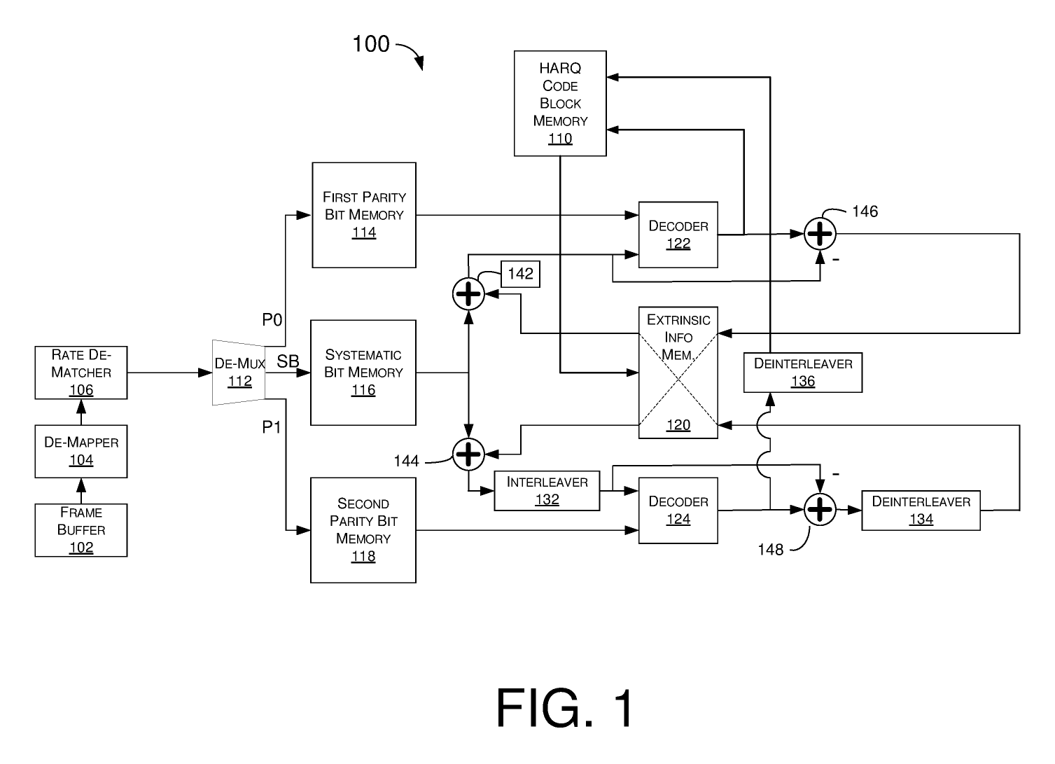

FIG. 1 illustrates an example architecture 100 for high-rate turbo code HARQ in accordance with an implementation of the present disclosure. Architecture 100 may be utilized in a receiver to perform various functions related to techniques, methods and systems described herein, including example process 400 described below. In some implementations, architecture 100 may be implemented in a communication apparatus which may be, for example, a network element (e.g., an E-UTRAN Node B or an equivalent network node in a wireless network) or a user equipment (e.g., a mobile handset, a smartphone, a tablet computing device, a wearable computing device). For illustrative purpose and not limiting the scope of the present disclosure, example implementations of architecture 100 described below may be provided in the context of architecture 100 being implemented in a network node or a use equipment of a wireless or radio communication network (e.g., an LTE or LTE-Advanced communication network).

Architecture 100 may include some or all of those functional blocks or components shown in FIG. 1, including a frame buffer 102, a de-mapper 104, a rate de-matcher 106, a HARQ code block memory 110, a de-multiplexer 112, a first parity bit memory 114, a systematic bit memory 116, a second parity bit memory 118, a first decoder 122, a second decoder 124, an extrinsic information memory 120, an interleaver 132, a first deinterleaver 134, a second deinterleaver 136, and combiners 142, 144, 146 and 148. Architecture 100 may further include other functional blocks or components that may be necessary for the performance of wireless receiving but, for the sake of simplicity and not obscuring FIG. 1, are not shown in FIG. 1. In some implementations, at least some of frame buffer 102, de-mapper 104, rate de-matcher 106, HARQ code block memory 110, de-multiplexer 112, first parity bit memory 114, systematic bit memory 116, second parity bit memory 118, first decoder 122, second decoder 124, extrinsic information memory 120, interleaver 132, first deinterleaver 134, second deinterleaver 136, and combiners 142, 144, 146 and 148 may be implemented as integral parts of a receiver which may be in the form or a single integrated-circuit (IC) chip or one or more IC chips of a chipset.

De-mapper 104 may be configured to de-map a plurality of coded bits of an encoded signal Dᵢₙ. In some implementations, in de-mapping the plurality of coded bits of the encoded signal Dᵢₙ, de-mapper 104 may be configured to de-map one or more retransmission packets for incremental redundancy of HARQ, e.g., for full incremental redundancy or partial incremental redundancy.

Rate de-matcher 106 may be coupled to de-mapper 104, and may be configured to perform a single-stage rate de-matching of the coded bits of encoded signal Dᵢₙ. In some implementations, in performing the single-stage rate de-matching of the coded bits, rate de-matcher 106 may be configured to rate de-match the coded bits from a number of bits transportable on the physical channel over a communication network.

HARQ code block memory 110 may be configured to store one or more packets of an initial transmission received previously.

De-multiplexer 112 may be configured to separate a stream of bits from rate de-matcher 106 containing a result of the single-stage rate de-matching into a plurality of systematic bits (denoted as “SB” herein), a plurality of first parity bits (denoted as “P0” herein) and a plurality of second parity bits (denoted as “P1” herein).

Systematic bit memory 116 may be coupled to de-multiplexer 112 to receive and store systematic bits SB therein, e.g., in a block by block fashion. First parity bit memory 114 may be coupled to de-multiplexer 112 to receive and store first parity bits P0 therein, e.g., in a block by block fashion. Second parity bit memory 118 may be coupled to de-multiplexer 112 to receive and store second parity bits P1 therein, e.g., in a block by block fashion. In some implementations, the capacity of each of systematic bit memory 116, first parity bit memory 114 and second parity bit memory 118 may be the same as the capacity of HARQ code block memory 110.

Frame buffer 102 may be configured to store a plurality of coded bits of an encoded signal Din. In some implementations, the capacity of frame buffer 102 may be the same as the capacity of each of systematic bit memory 116, first parity bit memory 114 and second parity bit memory 118. In some implementations, the capacity of each of HARQ code block memory 110, systematic bit memory 116, first parity bit memory 114, second parity bit memory 118 and frame buffer 102 may be the same.

Referring to FIG. 1, interleaver 132 may be configured to interleave a second combined output to provide an interleaved output. Combiner 146 may be configured to combine a first decoded output and a first combined output to provide a third combined output. Combiner 148 may be configured to combine a second decoded output and the interleaved output to provide a fourth combined output. First deinterleaver 134 may be configured to deinterleave the fourth combined output to provide a first deinterleaved output. Second deinterleaver 136 may be configured to deinterleave the second decoded output to provide a second deinterleaved output. HARQ code block memory 110 may receive and store the first decoded output and the second deinterleaved output. Extrinsic information memory 120 may be configured to receive an output of HARQ code block memory 110. Extrinsic information memory 120 may be also configured to store the third combined output or the first deinterleaved output. Combiner 142 may be configured to combine information comprising an output of systematic bit memory 116 and the first output of extrinsic information memory 120 to provide a first combined output. Combiner 144 may be configured to combine information including at least the output of systematic bit memory 116 and the second output of extrinsic information memory 120 to provide the second combined output. First decoder 122 may be configured to decode information including an output of first parity bit memory 114 and the first combined output to provide the first decoded output. Second decoder 124 may be configured to decode information including an output of second parity bit memory 118 and the interleaved output to provide the second decoded output.

Advantageously, architecture 100 saves away the internally decoded intrinsic probability information and extrinsic probability information from the final iteration. Architecture 100 may restore previous intrinsic probability information and extrinsic probability information back to the extrinsic information memory 120. Accordingly, architecture 100 allows a receiver to take advantage of the incremental redundancy transmitted to the receiver beyond the limits of what HARQ can store.

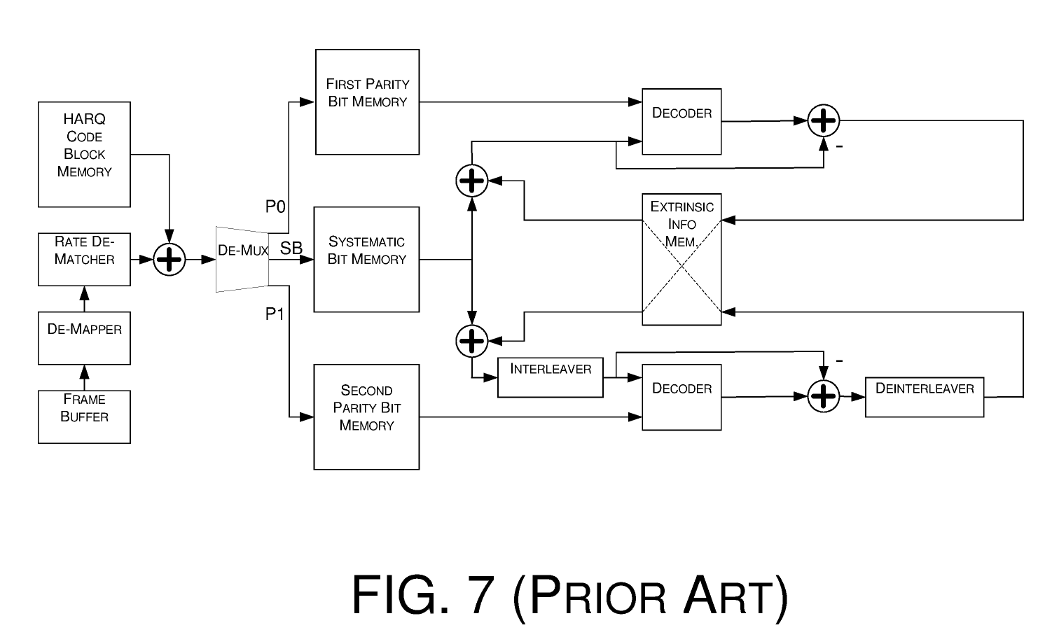

In some implementations, architecture 100 may be switched over to being used after the second re-transmission fails to decode correctly, otherwise a prior art architecture, such as that shown in FIG. 7, could be used up until this point.

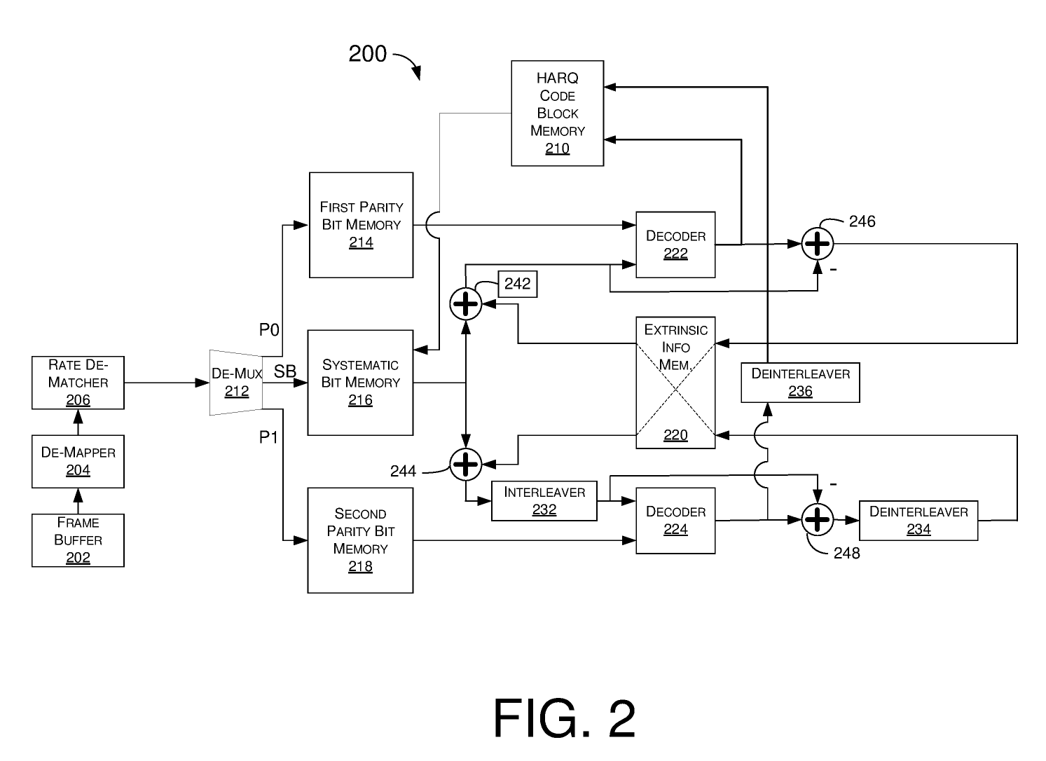

FIG. 2 illustrates an example architecture 200 for high-rate turbo code HARQ in accordance with an implementation of the present disclosure. Architecture 200 may be utilized in a receiver to perform various functions related to techniques, methods and systems described herein, including example process 500 described below. In some implementations, architecture 200 may be implemented in a communication apparatus which may be, for example, a network element (e.g., an E-UTRAN Node B or an equivalent network node in a wireless network) or a user equipment (e.g., a mobile handset, a smartphone, a tablet computing device, a wearable computing device). For illustrative purpose and not limiting the scope of the present disclosure, example implementations of architecture 200 described below may be provided in the context of architecture 200 being implemented in a network node or a use equipment of a wireless or radio communication network (e.g., an LTE or LTE-Advanced communication network).

Architecture 200 may include some or all of those functional blocks or components shown in FIG. 2, including a frame buffer 202, a de-mapper 204, a rate de-matcher 206, a HARQ code block memory 210, a de-multiplexer 212, a first parity bit memory 214, a systematic bit memory 216, a second parity bit memory 218, a first decoder 222, a second decoder 224, an extrinsic information memory 220, an interleaver 232, a first deinterleaver 234, a second deinterleaver 236, and combiners 242, 244, 246 and 248. Architecture 200 may further include other functional blocks or components that may be necessary for the performance of wireless receiving but, for the sake of simplicity and not obscuring FIG. 2, are not shown in FIG. 2. In some implementations, at least some of frame buffer 202, de-mapper 204, rate de-matcher 206, HARQ code block memory 210, de-multiplexer 212, first parity bit memory 214, systematic bit memory 216, second parity bit memory 218, first decoder 222, second decoder 224, extrinsic information memory 220, interleaver 232, first deinterleaver 234, second deinterleaver 236, and combiners 242, 244, 246 and 248 may be implemented as integral parts of a receiver which may be in the form or a single IC chip or one or more IC chips of a chipset.

De-mapper 204 may be configured to de-map a plurality of coded bits of an encoded signal Dᵢₙ. In some implementations, in de-mapping the plurality of coded bits of the encoded signal Dᵢₙ, de-mapper 204 may be configured to de-map one or more retransmission packets for incremental redundancy of HARQ, e.g., for full incremental redundancy or partial incremental redundancy.

Rate de-matcher 206 may be coupled to de-mapper 204, and may be configured to perform a single-stage rate de-matching of the coded bits of encoded signal Dᵢₙ. In some implementations, in performing the single-stage rate de-matching of the coded bits, rate de-matcher 206 may be configured to rate de-match the coded bits from a number of bits transportable on the physical channel over a communication network.

HARQ code block memory 210 may be configured to store one or more packets of an initial transmission received previously.

De-multiplexer 212 may be configured to separate a stream of bits from de-matcher 206 containing a result of the single-stage rate de-matching into a plurality of systematic bits (denoted as “SB” herein), a plurality of first parity bits (denoted as “P0” herein) and a plurality of second parity bits (denoted as “P1” herein).

Systematic bit memory 216 may be coupled to de-multiplexer 212 to receive and store systematic bits SB therein, e.g., in a block by block fashion. First parity bit memory 214 may be coupled to de-multiplexer 212 to receive and store first parity bits P0 therein, e.g., in a block by block fashion. Second parity bit memory 218 may be coupled to de-multiplexer 212 to receive and store second parity bits P1 therein, e.g., in a block by block fashion. In some implementations, the capacity of each of systematic bit memory 216, first parity bit memory 214 and second parity bit memory 218 may be the same as the capacity of HARQ code block memory 210.

Frame buffer 202 may be configured to store a plurality of coded bits of an encoded signal Dᵢₙ. In some implementations, the capacity of frame buffer 202 may be the same as the capacity of each of systematic bit memory 216, first parity bit memory 214 and second parity bit memory 218. In some implementations, the capacity of each of HARQ code block memory 210, systematic bit memory 216, first parity bit memory 214, second parity bit memory 218 and frame buffer 202 may be the same.

Referring to FIG. 2, interleaver 232 may be configured to interleave a second combined output to provide an interleaved output. Combiner 246 may be configured to combine the first decoded output and a first combined output to provide a third combined output. Combiner 248 may be configured to combine a second decoded output and the interleaved output to provide a fourth combined output. First deinterleaver 234 may be configured to deinterleave the fourth combined output to provide a first deinterleaved output. Second deinterleaver 236 may be configured to deinterleave the second decoded output to provide the second deinterleaved output. HARQ code block memory 210 may receive and store the first decoded output and the second deinterleaved output. Extrinsic information memory 220 may be configured to receive an output of HARQ code block memory 210. Extrinsic information memory 220 may be also configured to store the third combined output or the first deinterleaved output. Combiner 242 may be configured to combine information including at least an output of systematic bit memory 216 and the first output of extrinsic information memory 220 to provide the first combined output. Combiner 244 may be configured to combine information including at least the output of systematic bit memory 216 and the second output of extrinsic information memory 220 to provide the second combined output. First decoder 222 may be configured to decode information including an output of first parity bit memory 214 and the first combined output to provide the first decoded output. Second decoder 224 may be configured to decode information including an output of second parity bit memory 218 and the interleaved output to provide the second decoded output.

Advantageously, architecture 200 saves away the internally decoded intrinsic probability information and extrinsic probability information from the final iteration. Architecture 200 may restore previous intrinsic probability information and extrinsic probability information back to the systematic bit memory 216. Accordingly, architecture 200 allows a receiver to take advantage of the incremental redundancy transmitted to the receiver beyond the limits of what HARQ can store.

in some implementations, architecture 200 may be switched over to being used after the second re-transmission fails to decode correctly, otherwise a prior art architecture, such as that shown in FIG. 7, could be used up until this point.

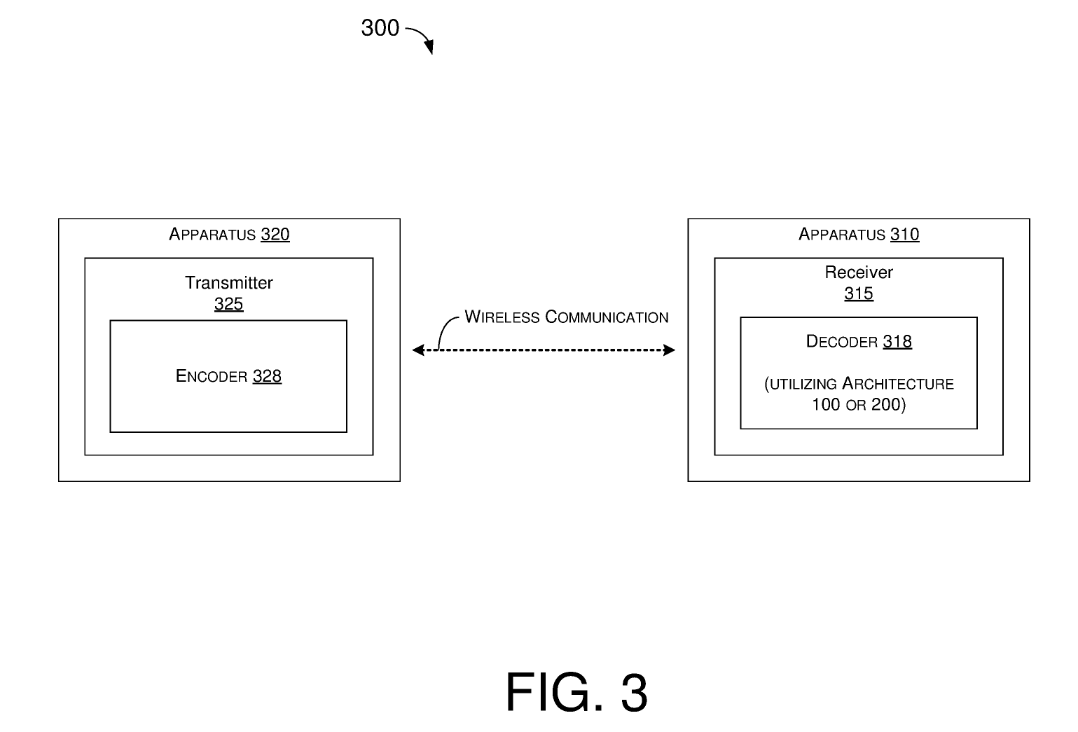

FIG. 3 is a simplified diagram of an example communication system 300 in accordance with at least some implementations of the present disclosure. Communication system may be, for example and not limited to, an LTE or LTE-Advanced communication system. In communication system 300, a first apparatus 310 and a second apparatus 320 may be in wireless communication. Each of first apparatus 310 and second apparatus 320 may be equipped with respective transmitter and receiver. Nevertheless, to avoid obscuring the illustration, a receiver 315 of first apparatus 310 and a transmitter 325 of apparatus 320 are shown in FIG. 3, although apparatus 310 may also include a respective transmitter and apparatus 320 ma also include a respective receiver.

Receiver 315 may include a decoder 318 in accordance with the present disclosure. Specifically, decoder 318 may be implemented with hardware, firmware and software components associated with either architecture 100 or architecture 200 described above. Transmitter 325 may include an encoder 328 in accordance with the present disclosure. Specifically, encoder 328 may be implemented with hardware, firmware and software components associated with an encoder architecture that corresponds to either architecture 100 or architecture 200 described above. When architecture 100 is implemented in decoder 318, receiver 315 may include at least those functions and/or components of architecture 100 described above with reference to FIG. 1. When architecture 200 is implemented in decoder 318, receiver 315 may include at least those functions and/or components of architecture 200 described above with reference to FIG. 2. Accordingly, features and advantages associated with each of architecture 100 and architecture 200 may be implemented, performed or otherwise achieved by decoder 318. That is, the description above with respect to architecture 100 and architecture 200 applies to decoder 318 and receiver 315. Thus, advantageously, decoder 318 of receiver 315 may retain internally decoded intrinsic information and/or extrinsic information which would be otherwise discarded from the final iteration, and decoder 318 may combine the retained internally decoded intrinsic information and/or extrinsic information with any new systematic and parity information bits received through re-transmission from transmitter 325. In the interest of brevity and to avoid redundancy, a detailed description of decoder 318 is not provided.

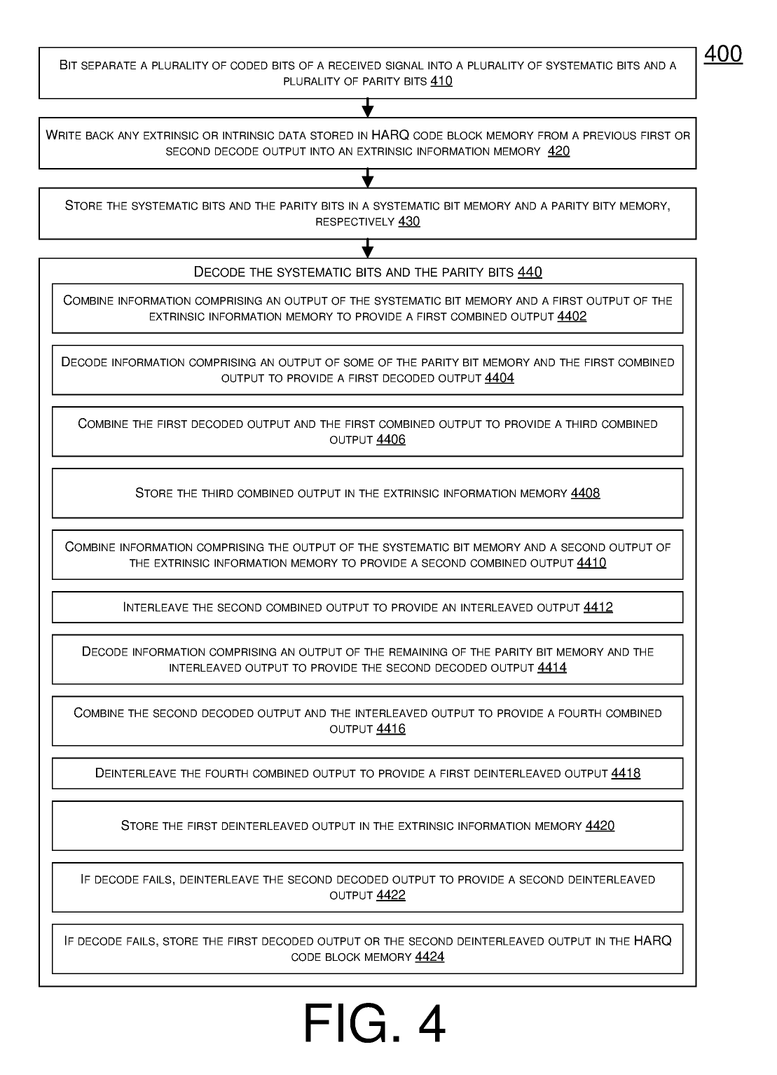

FIG. 4 is a flowchart of an example process 400 implementable in a receiver in accordance with an implementation of the present disclosure. Process 400 may include one or more operations, actions, or functions as represented by one or more of blocks 410, 420, 430 and 440 as well as sub-blocks 4402-4424. Although illustrated as discrete blocks, various blocks of process 400 may be divided into additional blocks, combined into fewer blocks, or eliminated, depending on the desired implementation. The blocks and sub-blocks of process 400 may be performed in the order shown in FIG. 4 or in any other order, depending on the desired implementation. Process 400 may be implemented by architecture 100 and apparatus 310 as well as any variations and/or derivatives thereof. Solely for illustrative purposes and without limitation, process 400 is described below in the context of decoder 318 of receiver 315 of apparatus 310 utilizing architecture 100. Process 400 may begin at block 410.

At 410, process 400 may involve decoder 318 of receiver 315 of apparatus 310 bit separating a stream of bits into a plurality of systematic bits and a plurality of parity bits for decoding. Process 400 may proceed from 410 to 420.

At 420, process 400 may involve decoder 318 writing back any extrinsic or intrinsic data stored in a HARQ code block memory from a previous first or second decode output into an extrinsic information memory. Process 400 may proceed from 420 to 430.

At 430, process 400 may involve decoder 318 storing the systematic bits and the parity bits in a systematic bit memory and a parity bit memory, respectively. Process 400 may proceed from 430 to 440.

At 440, process 400 may involve decoder 318 decoding the systematic bits and the parity bits by performing a number of operations, as illustrated in sub-blocks 4402-4424.

It is noteworthy that decoder 318 may perform the operations associated with sub-blocks 4402-4424 in any order or simultaneously. Thus, the order in which sub-blocks 4402-4424 are numbered and described below is in no way a limitation or constraint on how decode structure 318 carries out the operations to decode the systematic bits, the first parity bits and the second parity bits.

At 4402, process 400 may involve decoder 318 combining information comprising an output of the systematic bit memory and a first output of the extrinsic information memory to provide a first combined output.

At 4404, process 400 may involve decoder 318 decoding information comprising an output of some of the parity bit memory and the first combined output to provide a first decoded output.

At 4406, process 400 may involve decoder 318 combining the first decoded output and the first combined output to provide a third combined output.

At 4408, process 400 may involve decoder 318 storing the third combined output in the extrinsic information memory.

At 4410, process 400 may involve decoder 318 combining information comprising the output of the systematic bit memory and a second output of the extrinsic information memory to provide a second combined output.

At 4412, process 400 may involve decoder 318 interleaving the second combined output to provide an interleaved output.

At 4414, process 400 may involve decoder 318 decoding information comprising an output of the remaining of the parity bit memory and the interleaved output to provide the second decoded output.

At 4416, process 400 may involve decoder 318 combining the second decoded output and the interleaved output to provide a fourth combined output.

At 4418, process 400 may involve decoder 318 deinterleaving the fourth combined output to provide a first deinterleaved output.

At 4420, process 400 may involve decoder 318 storing the first deinterleaved output in the extrinsic information memory.

At 4422, in an event of a failed decode operation, process 400 may involve decoder 318 deinterleaving the second decoded output to provide a second deinterleaved output.

At 4424, in an event of the failed decode operation, process 400 may involve decoder 318 storing the first decoded output or the second deinterleaved output in the HARQ code block memory.

In some implementations, process 400 may further involve de-mapper 104 of decoder 318 de-mapping a plurality of coded bits of an encoded signal to provide a plurality of de-mapped coded bits by de-mapping one or more retransmission packets for incremental redundancy of HARQ. Additionally, process 400 may involve rate de-matcher 106 of decoder 318 performing rate de-matching of the plurality of de-mapped coded bits to provide a plurality of rate de-matched coded bits.

In some implementations, in performing the rate de-matching of the plurality of de-mapped coded bits, process 400 may involve ate de-matcher 106 of decoder 318 performing a single-stage rate de-matching of the plurality of coded bits from a number of bits transportable on a physical channel over a communication network.

In some implementations, in decoding the systematic bits, the first parity bits, and the second parity bits, process 400 may involve decoder 318 decoding the systematic bits, the first parity bits, and the second parity bits as part of a retransmission for HARQ.

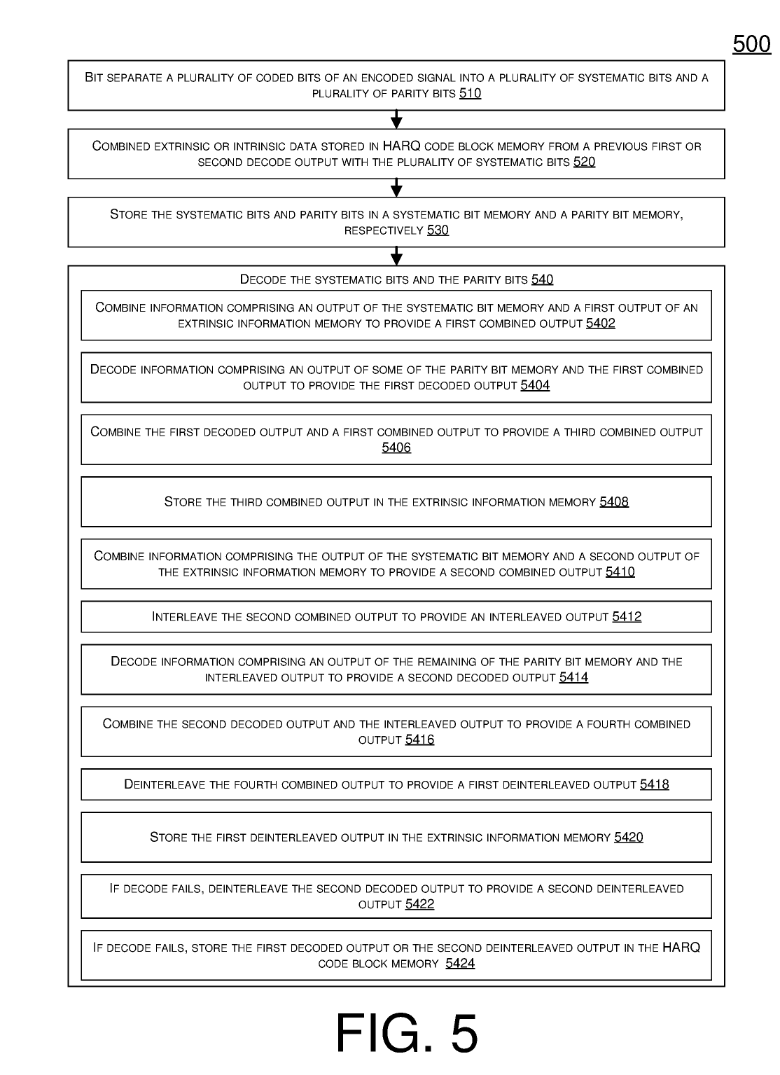

FIG. 5 is a flowchart of an example process 500 implementable in a receiver in accordance with another implementation of the present disclosure. Process 500 may include one or more operations, actions, or functions as represented by one or more of blocks 510, 520, 530 and 540 as well as sub-blocks 5402-5424. Although illustrated as discrete blocks, various blocks of process 500 may be divided into additional blocks, combined into fewer blocks, or eliminated, depending on the desired implementation. The blocks and sub-blocks of process 500 may be performed in the order shown in FIG. 5 or in any other order, depending on the desired implementation. Process 500 may be implemented by architecture 200 and apparatus 310 as well as any variations and/or derivatives thereof. Solely for illustrative purposes and without limitation, process 500 is described below in the context of decoder 318 of receiver 315 of apparatus 310 utilizing architecture 200. Process 500 may begin at block 510.

At 510, process 500 may involve decoder 318 of receiver 315 of apparatus 310 bit separating a stream of bits into a plurality of systematic bits and a plurality of parity bits for decoding. Process 500 may proceed from 510 to 520.

At 520, process 500 may involve decoder 318 combining extrinsic or intrinsic data stored in a HARQ code block memory from a previous first or second decode output with the plurality of systematic bits. Process 500 may proceed from 520 to 530.

At 530, process 500 may involve decoder 318 storing the systematic bits and parity bits in a systematic bit memory and a parity bit memory, respectively. Process 500 may proceed from 530 to 540.

At 540, process 500 may involve decoder 318 decoding the systematic bits and the parity bits by performing a number of operations, as illustrated in sub-blocks 5402-5424.

It is noteworthy that decoder 318 may perform the operations associated with sub-blocks 5402-5424 in any order or simultaneously. Thus, the order in which sub-blocks 5402-5424 are numbered and described below is in no way a limitation or constraint on how decode structure 318 carries out the operations to decode the systematic bits, the first parity bits and the second parity bits.

At 5402, process 500 may involve decoder 318 combining information comprising an output of the systematic bit memory and a first output of an extrinsic information memory to provide a first combined output.

At 5404, process 500 may involve decoder 318 decoding information comprising an output of some of the parity bit memory and the first combined output to provide a first decoded output.

At 5406, process 500 may involve decoder 318 combining the first decoded output and the first combined output to provide a third combined output.

At 5408, process 500 may involve decoder 318 storing the third combined output in the extrinsic information memory.

At 5410, process 500 may involve decoder 318 combining information comprising the output of the systematic bit memory and a second output of the extrinsic information memory to provide a second combined output.

At 5412, process 500 may involve decoder 318 interleaving the second combined output to provide an interleaved output.

At 5414, process 500 may involve decoder 318 decoding information comprising an output of the remaining of the parity bit memory and the interleaved output to provide a second decoded output.

At 5416, process 500 may involve decoder 318 combining the second decoded output and the interleaved output to provide a fourth combined output.

At 5418, process 500 may involve decoder 318 deinterleaving the fourth combined output to provide a first deinterleaved output.

At 5420, process 500 may involve decoder 318 storing the first deinterleaved output in the extrinsic information memory.

At 5422, in an event of a failed decode operation, process 500 may involve decoder 318 deinterleaving the second decoded output to provide a second deinterleaved output.

At 5424, in an event of the failed decode operation, process 500 may involve decoder 318 storing the first decoded output or the second deinterleaved output in the HARQ code block memory.

In some implementations, process 500 may further involve de-mapper 204 of decoder 318 de-mapping a plurality of coded bits of an encoded signal to provide a plurality of de-mapped coded bits by de-mapping one or more retransmission packets for incremental redundancy of HARQ. Additionally, process 500 may involve rate de-matcher 206 of decoder 318 performing rate de-matching of the plurality of de-mapped coded bits to provide a plurality of rate de-matched coded bits.

In some implementations, in performing the rate de-matching of the plurality of de-mapped coded bits, process 500 may involve ate de-matcher 206 of decoder 318 performing a single-stage rate de-matching of the plurality of coded bits from a number of bits transportable on a physical channel over a communication network.

In some implementations, in decoding the systematic bits, the first parity bits, and the second parity bits, process 500 may involve decoder 318 decoding the systematic bits, the first parity bits, and the second parity bits as part of a retransmission for HARQ.

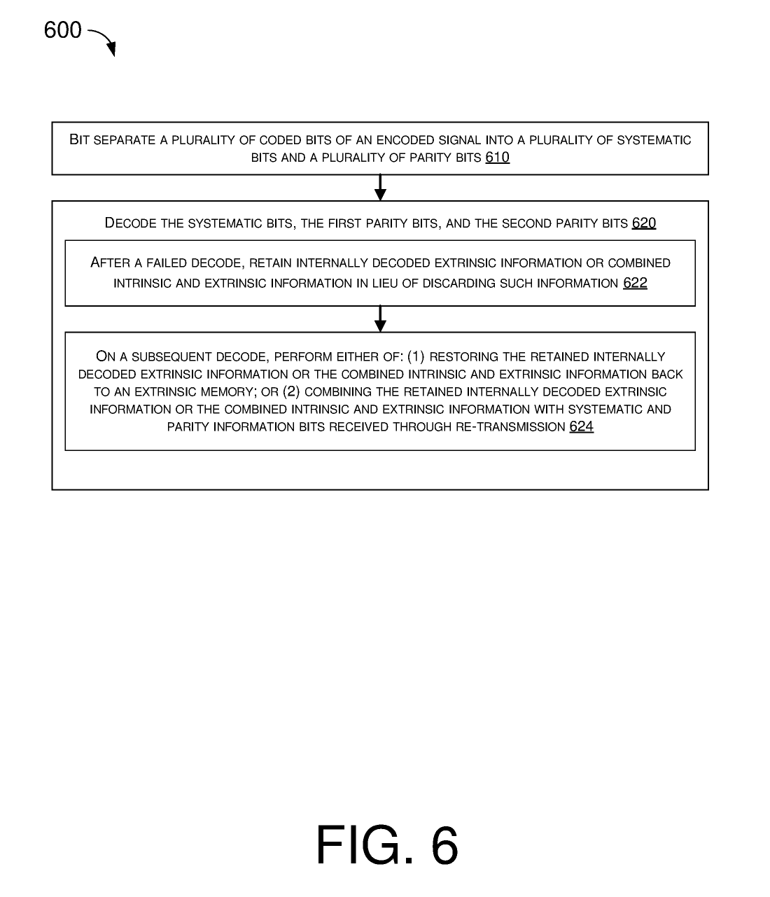

FIG. 6 is a flowchart of an example process implementable in a receiver in accordance with another implementation of the present disclosure. Process 600 may include one or more operations, actions, or functions as represented by one or more of blocks 610 and 620 as well as sub-blocks 622 and 624. Although illustrated as discrete blocks, various blocks of process 600 may be divided into additional blocks, combined into fewer blocks, or eliminated, depending on the desired implementation. The blocks and sub-blocks of process 600 may be performed in the order shown in FIG. 6 or in any other order, depending on the desired implementation. Process 600 may be implemented by architecture 100, architecture 200 and/or apparatus 310 as well as any variations and/or derivatives thereof. Solely for illustrative purposes and without limitation, process 600 is described below in the context of decoder 318 of receiver 315 of apparatus 310. Process 600 may begin at block 610.

At 610, process 600 may involve decoder 318 of receiver 315 of apparatus 310 bit separating a stream of bits into a plurality of systematic bits and a plurality of parity bits for decoding. Process 600 may proceed from 610 to 620.

At 620, process 600 may involve decoder 318 decoding the systematic bits and the parity bits by performing a number of operations, as illustrated in sub-blocks 622 and 624.

At 622, after a failed decode operation, process 600 may involve decoder 318 retaining internally decoded extrinsic information or combined intrinsic and extrinsic information in lieu of discarding such information (i.e., the internally decoded extrinsic information or the combined intrinsic and extrinsic information). Process 600 may proceed from 622 to 624.

At 624, on a subsequent decode operation, process 600 may involve decoder 318 performing either of: (1) restoring the retained internally decoded extrinsic information or the combined intrinsic and extrinsic information back to an extrinsic memory; or (2) combining the retained internally decoded extrinsic information or the combined intrinsic and extrinsic information with systematic and parity information bits received through re-transmission.

In some implementations, in decoding the systematic bits and the parity bits, process 600 may involve decoder 318 performing a number of operations pertaining to architecture 100. For instance, process 600 may involve decoder 318 performing the following: (a) storing the systematic bits and the parity bits in a systematic bit memory and a parity bit memory, respectively; (b) interleaving, by an interleaver, a second combined output to provide an interleaved output; (c) combining, by a third combiner, a first decoded output and a first combined output to provide a third combined output; (d) combining, by a fourth combiner, a second decoded output and the interleaved output to provide a fourth combined output; (e) deinterleaving, by a first deinterleaver, the fourth combined output to provide a first deinterleaved output; (f) deinterleaving, by a second deinterleaver, the second decoded output to provide a second deinterleaved output; (g) storing the first decoded output, the third combined output, the first deinterleaved output, and the second deinterleaved output in an extrinsic information memory; (h) combining, by a first combiner, information comprising an output of the systematic bit memory and a first output of the extrinsic information memory to provide the first combined output, the first output of the extrinsic information memory comprising at least a portion of the first deinterleaved output, at least a portion of the first decoded output, and at least a portion of the second deinterleaved output; (i) combining, by a second combiner, information comprising the output of the systematic bit memory and a second output of the extrinsic information memory to provide the second combined output, the second output of the extrinsic information memory comprising at least a portion of the third combined output, at least a portion of the first decoded output, and at least a portion of the second deinterleaved output; (j) decoding, by a first decoder, information comprising an output of some of the parity bit memory and the first combined output to provide the first decoded output; and (k) decoding, by a second decoder, information comprising an output of remaining of the parity bit memory and the interleaved output to provide the second decoded output.

In some implementations, in decoding the systematic bits and the parity bits, process 600 may involve decoder 318 performing additional operations. For instance, process 600 may involve decoder 318 performing the following: (I) de-mapping a plurality of coded bits of a received encoded signal to provide a plurality of de-mapped coded bits by de-mapping one or more retransmission packets for incremental redundancy of HARQ; and (m) performing rate de-matching of the plurality of de-mapped coded bits to provide a plurality of rate de-matched coded bits. In some implementations, in performing the rate de-matching of the plurality of de-mapped coded bits, process 600 may involve decoder 318 performing a single-stage rate de-matching of the plurality of coded bits from a number of bits transportable on a physical channel over a communication network.

In some implementations, in decoding the systematic bits and the parity bits, process 600 may involve decoder 318 performing further operations. For instance, process 600 may involve decoder 318 performing the following: (n) combining the rate de-matched coded bits with one or more packets of an initial transmission received previously to provide the stream of bits for the bit streaming.

In some implementations, in decoding the systematic bits and the parity bits, process 600 may involve decoder 318 decoding the systematic bits and the parity bits as part of a retransmission for HARQ.

Alternatively, in decoding the systematic bits and the parity bits, process 600 may involve decoder 318 performing a number of operations pertaining to architecture 200. For instance, process 600 may involve decoder 318 performing the following: (a) storing the parity bits in a parity bit memory; (b) storing information comprising the systematic bits, a first decoded output, and a second deinterleaved output in a systematic bit memory; (c) interleaving, by an interleaver, a second combined output to provide an interleaved output; (d) combining, by a third combiner, the first decoded output and a first combined output to provide a third combined output; (e) combining, by a fourth combiner, a second decoded output and the interleaved output to provide a fourth combined output; (f) deinterleaving, by a first deinterleaver, the fourth combined output to provide a first deinterleaved output; (g) deinterleaving, by a second deinterleaver, the second decoded output to provide the second deinterleaved output; (h) storing the third combined output and the first deinterleaved output in an extrinsic information memory; (i) combining, by a first combiner, information comprising an output of the systematic bit memory and a first output of the extrinsic information memory to provide the first combined output, the first output of the extrinsic information memory comprising at least a portion of the first deinterleaved output; (j) combining, by the second combiner, information comprising the output of the systematic bit memory and a second output of the extrinsic information memory to provide the second combined output, the second output of the extrinsic information memory comprising at least a portion of the third combined output; (k) decoding, by a first decoder, information comprising an output of some of the parity bit memory and the first combined output to provide the first decoded output; and (I) decoding, by a second decoder, information comprising an output of remaining of the parity bit memory and the interleaved output to provide the second decoded output.

In some implementations, in decoding the systematic bits and the parity bits, process 600 may involve decoder 318 performing additional operations. For instance, process 600 may involve decoder 318 performing the following: (m) de-mapping a plurality of coded bits of an encoded signal to provide a plurality of de-mapped coded bits by de-mapping one or more retransmission packets for incremental redundancy of HARQ; and (n) performing rate de-matching of the plurality of de-mapped coded bits to provide a plurality of rate de-matched coded bits. In some implementations, in performing the rate de-matching of the plurality of de-mapped coded bits, process 600 may involve decoder 318 performing a single-stage rate de-matching of the plurality of coded bits from a number of bits transportable on a physical channel over a communication network.

In some implementations, in decoding the systematic bits and the parity bits, process 600 may involve decoder 318 performing further operations. For instance, process 600 may involve decoder 318 performing the following: (o) combining the rate de-matched coded bits with one or more packets of an initial transmission received previously to provide the stream of bits for the bit streaming.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method implementable in a receiver of a communication system, comprising:
bit separating a stream of bits into a plurality of systematic bits and a plurality of parity bits; and
decoding the systematic bits and the parity bits by performing operations comprising:
after a failed decode, retaining internally decoded extrinsic information or combined intrinsic and extrinsic information in lieu of discarding the information; and
on a subsequent decode, performing:
restoring the retained internally decoded extrinsic information or the combined intrinsic and extrinsic information back to an extrinsic information memory; or
combining the retained internally decoded extrinsic information or the combined intrinsic and extrinsic information with systematic and parity information bits received through re-transmission.

2. The method of claim 1, wherein the decoding of the systematic bits and the parity bits comprises:
storing the systematic bits and the parity bits in a systematic bit memory and a parity bit memory, respectively;
interleaving, by an interleaver, a second combined output to provide an interleaved output;
combining, by a third combiner, a first decoded output and a first combined output to provide a third combined output;
combining, by a fourth combiner, a second decoded output and the interleaved output to provide a fourth combined output;
deinterleaving, by a first deinterleaver, the fourth combined output to provide a first deinterleaved output;
deinterleaving, by a second deinterleaver, the second decoded output to provide a second deinterleaved output;
storing the first decoded output, the third combined output, the first deinterleaved output, and the second deinterleaved output in an extrinsic information memory;
combining, by a first combiner, information comprising an output of the systematic bit memory and a first output of the extrinsic information memory to provide the first combined output, the first output of the extrinsic information memory comprising at least a portion of the first deinterleaved output, at least a portion of the first decoded output, and at least a portion of the second deinterleaved output;
combining, by a second combiner, information comprising the output of the systematic bit memory and a second output of the extrinsic information memory to provide the second combined output, the second output of the extrinsic information memory comprising at least a portion of the third combined output, at least a portion of the first decoded output, and at least a portion of the second deinterleaved output;
decoding, by a first decoder, information comprising an output of some of the parity bit memory and the first combined output to provide the first decoded output; and
decoding, by a second decoder, information comprising an output of remaining of the parity bit memory and the interleaved output to provide the second decoded output.

3. The method of claim 2, wherein the decoding of the systematic bits and the parity bits further comprises:
de-mapping a plurality of coded bits of a received encoded signal to provide a plurality of de-mapped coded bits by de-mapping one or more retransmission packets for incremental redundancy of hybrid automatic repeat request (HARQ).

4. The method of claim 3, wherein the decoding of the systematic bits and the parity bits further comprises:
performing rate de-matching of the plurality of de-mapped coded bits to provide a plurality of rate de-matched coded bits.

5. The method of claim 4, wherein the performing of the rate de-matching of the plurality of de-mapped coded bits comprises performing a single-stage rate de-matching of the plurality of coded bits from a number of bits transportable on a physical channel over a communication network.

6. The method of claim 1, wherein the decoding of the systematic bits and the parity bits comprises decoding the systematic bits and the parity bits as part of a retransmission for hybrid automatic repeat request (HARQ).

7. The method of claim 1, wherein the decoding of the systematic bits and the parity bits comprises:
storing the parity bits in a parity bit memory;
storing information comprising the systematic bits, a first decoded output, and a second deinterleaved output in a systematic bit memory;
interleaving, by an interleaver, a second combined output to provide an interleaved output;
combining, by a third combiner, the first decoded output and a first combined output to provide a third combined output;
combining, by a fourth combiner, a second decoded output and the interleaved output to provide a fourth combined output;
deinterleaving, by a first deinterleaver, the fourth combined output to provide a first deinterleaved output;
deinterleaving, by a second deinterleaver, the second decoded output to provide the second deinterleaved output;
storing the third combined output and the first deinterleaved output in an extrinsic information memory;
combining, by a first combiner, information comprising an output of the systematic bit memory and a first output of the extrinsic information memory to provide the first combined output, the first output of the extrinsic information memory comprising at least a portion of the first deinterleaved output;
combining, by the second combiner, information comprising the output of the systematic bit memory and a second output of the extrinsic information memory to provide the second combined output, the second output of the extrinsic information memory comprising at least a portion of the third combined output;
decoding, by a first decoder, information comprising an output of some of the parity bit memory and the first combined output to provide the first decoded output; and
decoding, by a second decoder, information comprising an output of remaining of the parity bit memory and the interleaved output to provide the second decoded output.

8. The method of claim 7, wherein the decoding of the systematic bits and the parity bits further comprises:
de-mapping a plurality of coded bits of an encoded signal to provide a plurality of de-mapped coded bits by de-mapping one or more retransmission packets for incremental redundancy of hybrid automatic repeat request (HARQ).

9. The method of claim 8, wherein the decoding of the systematic bits and the parity bits further comprises:
performing rate de-matching of the plurality of de-mapped coded bits to provide a plurality of rate de-matched coded bits.

10. The method of claim 9, wherein the performing of the rate de-matching of the plurality of de-mapped coded bits comprises performing a single-stage rate de-matching of the plurality of coded bits from a number of bits transportable on a physical channel over a communication network.

11. An apparatus, comprising:
a receiver, the receiver comprising a decoder configured to decode a stream of bits comprising a plurality of systematic bits and a plurality of parity bits by performing operations comprising:
retaining internally decoded intrinsic information or extrinsic information in lieu of discarding the internally decoded intrinsic information or the extrinsic information; and
combining the internally decoded intrinsic information or the extrinsic information with systematic and parity information bits received through re-transmission.

12. The apparatus of claim 11, wherein the decoder comprises:
a systematic bit memory configured to store the systematic bits;
a parity bit memory configured to store the parity bits;
an interleaver configured to interleave a second combined output to provide an interleaved output;
a third combiner configured to combine a first decoded output and a first combined output to provide a third combined output;
a fourth combiner configured to combine a second decoded output and the interleaved output to provide a fourth combined output;
a first deinterleaver configured to deinterleave the fourth combined output to provide a first deinterleaved output;
a second deinterleaver configured to deinterleave the second decoded output to provide a second deinterleaved output;
an extrinsic information memory configured to store the third combined output or the first deinterleaved output a first combiner configured to combine information comprising an output of the systematic bit memory and the first output of the extrinsic information memory to provide a first combined output;
a second combiner configured to combine information comprising the output of the systematic bit memory and the second output of the extrinsic information memory to provide the second combined output;
a first decoder configured to decode information comprising an output of some of the parity bit memory and the first combined output to provide the first decoded output; and
a second decoder configured to decode information comprising an output of remaining of the parity bit memory and the interleaved output to provide the second decoded output.

13. The apparatus of claim 12, wherein the decoder further comprises:
a de-mapper configured to de-map a plurality of coded bits of an encoded signal to provide a plurality of de-mapped coded bits by de-mapping one or more retransmission packets for incremental redundancy of hybrid automatic repeat request (HARQ).

14. The apparatus of claim 13, wherein the decoder further comprises:
a rate de-matcher configured to perform rate de-matching of the plurality of de-mapped coded bits to provide a plurality of rate de-matched coded bits.

15. The apparatus of claim 14, wherein the rate de-matcher comprises a single-stage rate de-matcher configured to perform a single-stage rate de-matching of the plurality of coded bits from a number of bits transportable on a physical channel over a communication network.

16. The apparatus of claim 11, wherein the decoder is configured to decode the systematic bits and the parity bits as part of a retransmission for hybrid automatic repeat request (HARQ).

17. The apparatus of claim 11, wherein the decoder comprises:
a systematic bit memory configured to store information comprising the systematic bits, a first decoded output, and a second deinterleaved output;
a parity bit memory configured to store the first parity bits;
an interleaver configured to interleave a second combined output to provide an interleaved output;
a third combiner configured to combine the first decoded output and a first combined output to provide a third combined output;
a fourth combiner configured to combine a second decoded output and the interleaved output to provide a fourth combined output;
a first deinterleaver configured to deinterleave the fourth combined output to provide a first deinterleaved output;
a second deinterleaver configured to deinterleave the second decoded output to provide the second deinterleaved output;
an extrinsic information memory configured to store the third combined output or the first deinterleaved output;
a first combiner configured to combine information comprising an output of the systematic bit memory and the first output of the extrinsic information memory to provide the first combined output;
a second combiner configured to combine information comprising the output of the systematic bit memory and the second output of the extrinsic information memory to provide the second combined output;
a first decoder configured to decode information comprising an output of some of the parity bit memory and the first combined output to provide the first decoded output; and
a second decoder configured to decode information comprising an output of remaining of the parity bit memory and the interleaved output to provide the second decoded output.

18. The apparatus of claim 17, wherein the decoder further comprises:
a de-mapper configured to de-map a plurality of coded bits of an encoded signal to provide a plurality of de-mapped coded bits by de-mapping one or more retransmission packets for incremental redundancy of hybrid automatic repeat request (HARQ)

19. The apparatus of claim 18, wherein the decoder further comprises:
a rate de-matcher configured to perform rate de-matching of the plurality of de-mapped coded bits to provide a plurality of rate de-matched coded bits.

20. The apparatus of claim 19, wherein the rate de-matcher comprises a single-stage rate de-matcher configured to perform a single-stage rate de-matching of the plurality of coded bits from a number of bits transportable on a physical channel over a communication network.
